(19) United States
(12) Patent Application Publication
(10) Pub. No.: US 2017/0319427 A1
(43) Pub. Date: Nov. 9, 2017

(54) HAND-HELD ROTARY DEVICE FOR TIGHTENING SKIN

(71) Applicant: Cindy Udhardt, Mannheim (DE)

(72) Inventor: Cindy Udhardt, Mannheim (DE)

(21) Appl. No.: 15/148,682

(22) Filed: May 6, 2016

(51) Int. Cl. A61H 15/00

(52) U.S. Cl. CPC A61H 15/0085; A61H 2201/1223; A61H 2015/0014; A61H 2201/0107

(57) ABSTRACT

A hand-held rotary device for tightening skin and tissue includes a handle attached to a cylindrical roller bar. A motor is disposed in a cavity of the handle, the motor having a drive shaft extending from the motor and providing the rotational force for the rotary device. The cylindrical roller bar is mounted on the drive shaft and has a cushioned and textured exterior surface.

### BACKGROUND OF THE INVENTIVE CONCEPTS

### 1. Field of the Inventive Concepts

The inventive concepts disclosed and claimed herein relate to a rotary device, and more particularly, but not by way of limitation, to a hand-held rotary device for tightening skin.

### 2. Brief Description of Related Art

The underarm is a place many women tend to store fat. Dieting and appropriate exercise can help to tone the arms, but these activities take considerable time and self-discipline and results are frequently not satisfactory. Numerous vibration and massage-type devices have been proposed for assisting in weight loss and in muscle toning. For example, massaging tissues using a gel-dispensing massager as in U.S. Pat. No. 6,511,445 is said to reduce cellulite and improve the texture of treated skin. Similarly, an exercise device having a motorized belt with rollers is disclosed in U.S. 2015/0367171 A1 and claims to break down fat cells, particularly abdominal or visceral fat cells. However, these devices are less helpful for toning under the arm.

In general, while equipment is available to assist in losing body fat, the equipment is less helpful for targeting soft loose flesh such as that commonly found under the arm. To this end, a need exists for a device that can be easily used and is effective in the reduction of fatty tissue located on the underside of the arm. It is to such devices and methods of using the same that the presently disclosed and claimed inventive concept(s) is directed.

### SUMMARY OF THE INVENTIVE CONCEPTS

The inventive concepts disclosed and claimed herein generally relate to a hand-held rotary device for tightening skin and tissue. In one embodiment, the device includes a handle attached to a cylindrical roller bar. A motor is disposed in a cavity of the handle, the motor having a drive shaft extending from the motor and providing the rotational force for the rotary device. The cylindrical roller bar is mounted on the drive shaft and has a cushioned and textured exterior surface.

In one embodiment, a kit includes a rotary device with a plurality of detachable cylindrical roller bars having a cushioned and textured exterior surface. In a related embodiment, an assembly includes the aforementioned kits and a display unit on which the kit(s) is disposed.

In yet another embodiment, a kit includes a rotary device with a plurality of sleeves having a cushioned and textured exterior surface. In a related embodiment, an assembly includes the aforementioned kits and a display unit on which the kit(s) is disposed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of one embodiment of a rotary device constructed in accordance with the presently disclosed inventive concept(s).

FIG. 2 is a sectional view taken along line 2-2 of FIG. 1.

FIG. 3 is a cross-sectional view of another rotary device embodiment showing a battery positioned therein.

FIG. 4 is a perspective view of a rotary device embodiment having a wire cage for holding a removable sleeve.

FIG. 5 is a perspective view of another rotary device embodiment having a wire cage for holding a removable sleeve.

FIG. 6 is a perspective view of a removable sleeve constructed in accordance with the presently disclosed inventive concept(s).

FIG. 7 is a sectional view taken along line 7-7 of FIG. 6.

FIG. 8 is a perspective view of another example rotary device embodiment having parallel elongated ridges.

FIG. 9 is a sectional view of another removable sleeve embodiment.

FIG. 10 shows a person applying a rotary device embodiment against the underside of her upper arm.

### DETAILED DESCRIPTION OF EXEMPLARY EMBODIMENTS

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

Turning now to the presently disclosed inventive concept(s), certain embodiments thereof are directed to a rotary device that can be hand-held and used to break down fat cells and tighten and firm the skin. Other embodiments are directed to kits and assemblies containing such rotary devices.

The presently disclosed inventive concept(s) possesses many benefits over the prior art. First, the rotary device disclosed or otherwise contemplated herein can be rotated against the skin or tissue requiring tightening to provide a repeated force against the skin and tissues beneath. This repetitive force is more effective than the vibration and massage treatments provided by previous devices. Certain embodiments of the presently disclosed inventive concept(s) will be described herein below with reference to the Drawings.

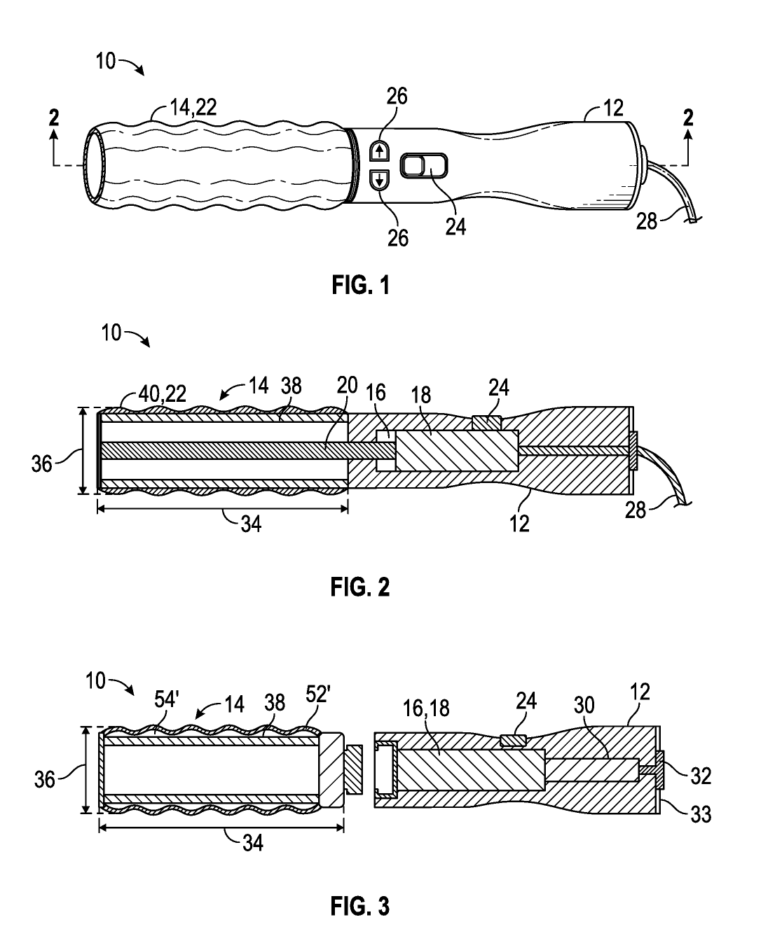

Referring now to FIG. 1 and FIG. 2, shown therein are embodiments of a hand-held rotary device constructed in accordance with the presently disclosed inventive concept(s). The rotary device 10 includes a handle 12 and a cylindrical roller bar 14. The handle 12 has an inner cavity 16 in which a motor 18 is disposed. The motor 18 includes a drive shaft 20 that extends from the handle 12 and provides the rotational force for the rotary device 10. The cylindrical roller bar 14 is mounted on the drive shaft 20 and has a cushioned and textured exterior surface 22.

In one embodiment, a switch 24 on the handle 12 controls power to the motor 18. The switch 24 toggles between and ON position and an OFF position.

In one embodiment, a single rotation rate is available and it is anticipated this rotation rate will be between 40 rpm and 250 rpm. In another embodiment, different rotation rate settings are available. For example, a LOW setting can cause the drive shaft to rotate at a rate in the range of from 40 rpm to 80 rpm, while a HIGH setting can cause the drive shaft to rotate at a rate in the range of from 90 rpm to 250 rpm. In yet another embodiment, the rotation rate is variable using, for example, a dial continuously increasing the rate from the LOW to the HIGH setting.

In one embodiment, directional controllers 26 determine the direction that the drive shaft 20 rotates and therefore the direction that the cylindrical roller bar 14 rotates. It is anticipated that a user will apply the rotary device 10 to the user's body such that the cylindrical roller bar 14 rotates away from the user's face upon contact.

In one embodiment, the motor 18 is powered by plugging a power cord 28 into an AC electrical socket or other power source.

In another embodiment shown in FIG. 3, the inner cavity 16 of the handle 12 houses one or more battery(s) 30 in electrical contact with the motor 18. The inner cavity 16 is accessed through a door 33 to change batteries when necessary. In some embodiments, a fitment 32 is located on the handle and configured to be mated to an AC adapter or to a battery recharging device.

The cylindrical roller bar 14 has a length 34 and diameter 36 that allow convenient and ergonomic use of the rotary device 10. Typically, the length 34 and diameter 36 are selected so that one hand of the user can comfortably hold the cylindrical roller bar 14 against a selected area of the body while the cylindrical roller bar 14 is rotating. In one embodiment, the length 34 is in a range of from about 3 inches to about 8 inches and the diameter 36 is in a range of from about 1 inch to about 4 inches.

The cylindrical roller bar 14 can be permanently attached to the drive shaft 20, or it can be detachable or removably attached as in FIG. 3 using a snap fit or other attaching means known to those skilled in the art.

In one embodiment, the cylindrical roller bar 14 has an inner tube 38 and a removable sleeve 40 providing the cushioned and textured exterior surface 22. For example, the removable sleeve 40 can be a washable, textured material that is wrapped about the inner tube 38 and held in place using one or more fasteners such as elastic, straps, VELCRO™, and the like.

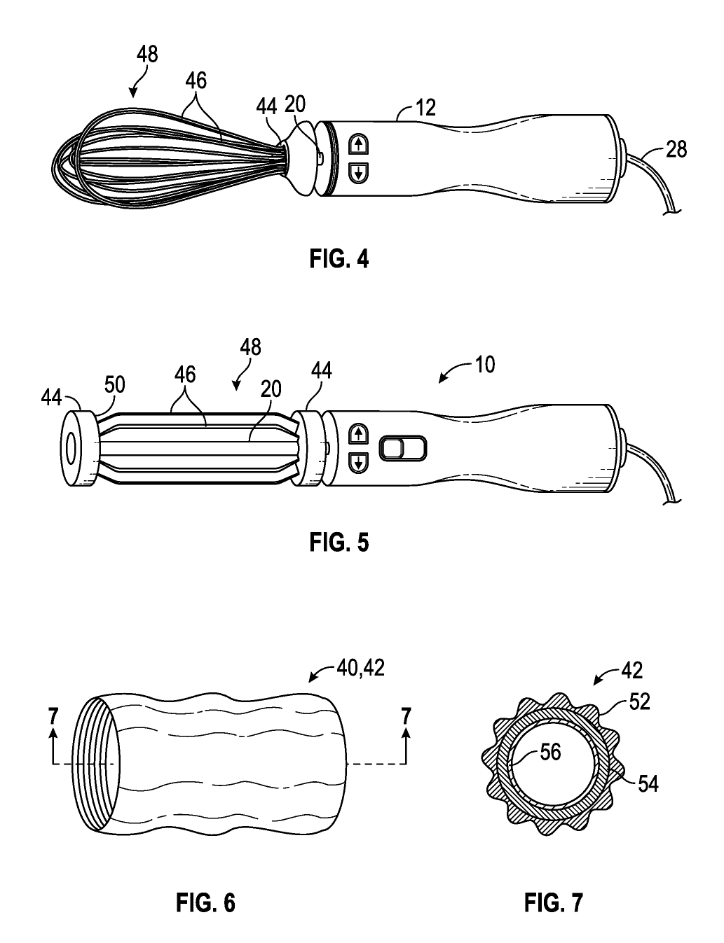

Referring now to FIG. 4, shown therein is a rotary device embodiment for use with a cylindrical sleeve 42 shown separately in FIG. 6 and FIG. 7. The cylindrical roller bar 14 includes a cylinder head 44 mounted on the drive shaft 20 and positioned adjacent the handle 12. A plurality of rigid wires 46 extend from one side of the cylinder head 44 to an opposite side of the cylinder head 44. The rigid wires 46 are spaced to form a wire cage 48 that can be compressed to fit within the cylindrical sleeve 42 and frictionally hold the cylindrical sleeve 42 in place.

An embodiment shown in FIG. 5 uses a pair of cylinder heads 44 mounted on the drive shaft 20. One cylinder head 44 is positioned adjacent the handle 12 and the other cylinder head 44 is positioned at an end 50 of the drive shaft 20. A plurality of rigid wires 46 extend between the cylinder heads 44 and are spaced to form a wire cage 48 that can be compressed to fit within the cylindrical sleeve 42 and frictionally hold the cylindrical sleeve 42 in place.

Referring now to FIG. 7, the cylindrical sleeve 42, as well as the cylindrical roller bar 14 of FIG. 1-FIG. 3, can have an outer textured layer 52 atop a cushion layer 54 attached to a rigid cylindrical form 56. The rigid cylindrical form can be made of metal or a rigid plastic and may be solid or mesh. The cushion layer 54 is glued or otherwise adhered or fastened to the rigid cylindrical form 56.

Referring back to FIG. 3, the cylindrical roller bar 14 can have a smooth outer layer 52′ atop and adhered to a cushion layer 54′ having a wavy, egg crate, or otherwise textured shape. The cushion layer 54′ is adhered to the inner tube 38, thereby providing a cylindrical roller bar having a cushioned and textured exterior surface.

In one embodiment the cushion layer 54 is composed predominantly from soft, resilient foam. Suitable soft, resilient foam materials include, but are not limited to, polyurethane, neoprene, polyethylene, and silicone. The foam can be open cell. The cushion layer 54 can be uniformly shaped or can be shaped to provide the textured surface such as an egg crate-shaped foam material.

In another embodiment, a single soft material can provide both the cushion and the textured outer surface for the cylindrical roller bar. Suitable materials include, but are not limited to, silicone, rubber, silicone rubber, polyurethane, gelastic materials, and the like.

The texturing feature(s) 58 of the exterior surface 22 are very important to achieve the desired effect when rotated against the skin. The textured exterior surface 22 should not slip against the skin because that would cause burning. The exterior surface must also not be abrasive as that would also damage the skin. Instead, the texturing feature should contact and actually move the skin momentarily, forcing the skin and underlying flesh to shake without burning or abrading the skin. It was discovered that this forced and rapid motion is superior to existing massage techniques for tightening the skin and reducing cellulite.

The rotary device described and claimed herein can be used to tighten the skin and tissue under the chin and neck area, under the fleshy upper arm area as in FIG. 10, and along the hips, abdomen, inner and back thigh areas, and buttocks. The rotary device encourages blood flow and is believed actually break down fat cells.

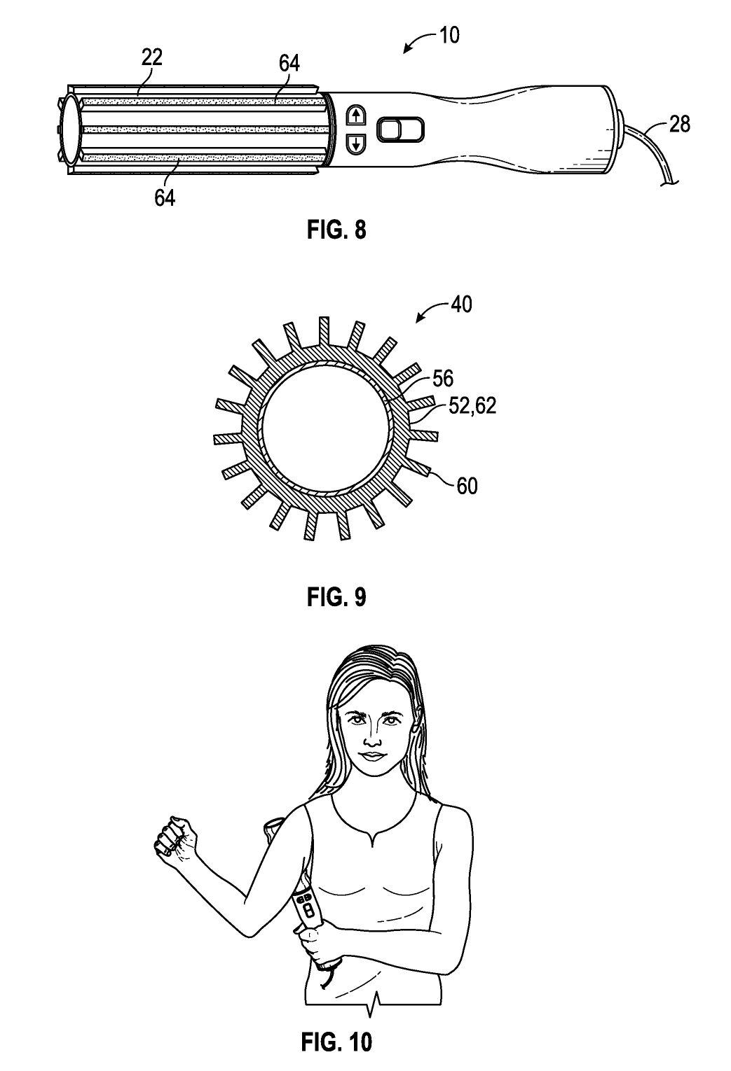

Suitable texturing features 58 include a pattern of raised surface portions 60 and lower surface portions 62. For example, the cylindrical roller bar in FIG. 8 and the removable sleeve in FIG. 9 have substantially parallel elongated ridges extending in a direction parallel to the drive shaft 20. However, other suitable texturing features can be used such as outwardly extending bumps and spines of any shape and in any combination.

The rotary device 10 may be formed in any manner known in the art or otherwise contemplated by a person having ordinary skill in the art, so long as the rotary device 10 can function in accordance with the presently disclosed inventive concept(s). The outer textured layer 52 and cushion layer 54 may be attached or otherwise associated with support surfaces of the cylindrical roller bar 14 by any methods known in the art or otherwise contemplated by a person having ordinary skill in the art. For example, but not by way of limitation, the outer textured layer 52 may be attached via a bonding material. The term “bonding material” as used herein will be understood to refer to any material that is sufficient to connect two elements to one another; in particular, the term “bonding material” will be understood to refer to any material that is sufficient to connect the outer textured layer 52 to an internal surface of the cylindrical roller bar 14. Examples of bonding materials include, but are not limited to, adhesives (including, but not limited to, pressure-sensitive adhesives and cold seal adhesives), cohesives, adhesive/cohesive combinations, heat sealable materials (such as, but not limited to, heat sealing lacquers or hot melt materials), sonically sealable materials (including, but not limited to, ultrasonically sealable materials), vibratory sealable materials, combinations thereof, and the like. Methods of forming rotary devices are well known in the art and are well within the knowledge of a person having ordinary skill in the art. Therefore, no further description on the production methods that may be employed is deemed necessary.

The rotary device 10 may further include one or more colors, designs, and/or patterns disposed on at least a portion thereof. The color(s), design(s), and/or pattern(s) may include, for example but not by way of limitation, packaging and/or labeling information, instructions for use, promotional material, company information, logos/trademarks, combinations thereof, and the like. The color(s), design(s) and/or pattern(s) may be disposed on the rotary device 10 (and/or the material from which the rotary device 10 is formed) by any method known in the art, including but not limited to, printing, etching, embossing, texturing, coating, lacquering, application during extrusion, and the like. The color(s), design(s) and/or pattern(s) may be applied separately or simultaneously and/or may be characterized totally or partially by pearlescent, translucent, transparent, iridescent, or other similar qualities. Each of the above-named characteristics may occur alone or in combination and may be applied to a portion of the rotary device 10 and/or the material from which the rotary device 10 is formed.

Another embodiment of the presently disclosed inventive concept(s) is directed to a kit containing at least one of the rotary devices described herein above with a plurality of detachable cylindrical roller bars having cushioned and textured exterior surfaces. Yet another embodiment of the presently disclosed inventive concept(s) is directed to a kit containing at least one of the rotary devices described herein above with a plurality of sleeves having cushioned and textured exterior surfaces.

The kits of the presently disclosed inventive concept(s) may further include a display unit on which at least a portion of the packaged product(s)/kit(s) may be disposed and thereby displayed. Display units are well known in the art, and therefore no further discussion thereof is deemed necessary.

Another embodiment of the presently disclosed inventive concept(s) is directed to an assembly. The assembly includes one or more of any of the rotary devices disclosed or otherwise contemplated herein (and/or one or more of the kits containing same) and a display unit on which at least a portion of the rotary device(s)/kit(s) is disposed and thereby displayed.

Although the presently disclosed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed inventive concept(s). Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. A hand-held rotary device for tightening skin and tissue, comprising:
a handle having an inner cavity;
a motor disposed in the cavity of the handle, the motor having a drive shaft extending from motor and providing the rotational force for the rotary device;
a cylindrical roller bar mountable to the drive shaft and having a cushioned and textured exterior surface.

2. The rotary device of claim 1, further comprising a power cord for powering the motor.

3. The rotary device of claim 1, further comprising a battery positioned within the inner cavity of the handle and electrically connected to the motor.

4. The rotary device of claim 3, further comprising a removable power cord connectable between the battery and a power source for recharging.

5. The rotary device of claim 1, wherein the cylindrical roller bar is detachable from the drive shaft.

6. The rotary device of claim 1, wherein the cylindrical roller bar comprises a removable sleeve providing the cushioned and textured exterior surface.

7. The rotary device of claim 6, wherein the cylindrical roller bar comprises an inner tube mountable on the drive shaft having a first VELCRO-type fastening element, and the removable sleeve comprises a washable material having a second VELCRO-type fastening element on an inner surface.

8. The rotary device of claim 6, wherein the cylindrical roller bar comprises:
a cylindrical sleeve having a cushioned and textured exterior surface;
a cylinder head mounted on the drive shaft and positioned adjacent the handle; and
a plurality of rigid wires extending from one side of the cylinder head to an opposite side of the cylindrical head and spaced to form a wire cage extending to frictionally fit within the cylindrical sleeve.

9. The rotary device of claim 6, wherein the cylindrical roller bar comprises:
a cylindrical sleeve having a cushioned and textured exterior surface;
a pair of cylinder heads on the drive shaft, one positioned adjacent the handle and another positioned at an end of the drive shaft; and
a plurality of rigid wires extending between the cylinder heads spaced to form a wire cage to frictionally fit within the cylindrical sleeve.

10. The rotary device of claim 1, wherein the cushioned and textured exterior surface comprises a texturing feature that includes substantially parallel elongated ridges extending in a direction parallel to the drive shaft.

11. The rotary device of claim 1, wherein the cushioned and textured exterior surface comprises a pattern of raised surface portions and lower surface portions.

12. The rotary device of claim 1, wherein the cushioned and textured exterior surface comprises a uniform or nonuniform array of bumps.

13. The rotary device of claim 1, wherein the cushioned and textured exterior surface resists slipping when rotated against a person's skin.

14. The rotary device of claim 1, further comprising a foam cushioning layer beneath a textured exterior surface layer.

15. The rotary device of claim 1, wherein the cushioned and textured exterior surface comprises a material selected from the group consisting of silicone, rubber, silicone rubber, polyurethane, gelastic materials, and combinations thereof.

16. The rotary device of claim 13, wherein the cushioned and textured exterior surface comprises outwardly extending features selected from bumps, spines, ridges, and combinations thereof.

17. A kit, comprising:
the rotary device of claim 5; and
a plurality of detachable cylindrical roller bars having a cushioned and textured exterior surface.

18. An assembly, comprising:
at least one of the kit of claim 17; and
a display unit on which the kit(s) is disposed.

19. A kit, comprising:
the rotary device of claim 6; and
a plurality of sleeves having a cushioned and textured exterior surface.

20. An assembly, comprising:
at least one of the kit of claim 19; and
a display unit on which the kit(s) is disposed.

21. An assembly comprising:
at least one of the rotary device of claim 1; and
a display unit on which the rotary device(s) is disposed.
